(19) United States
(12) Patent Application Publication
(10) Pub. No.: US 2022/0083999 A1
(43) Pub. Date: Mar. 17, 2022

(54) CAMPSITE UTILITY ACCESS PEDESTAL

(71) Applicant: R & L Connections, Forest, MS (US)

(72) Inventors: Damon Tucker, Forest, MS (US); Larry Crimm, Forest, MS (US)

(21) Appl. No.: 17/470,809

(22) Filed: Sep. 9, 2021

Related U.S. Application Data
(60) Provisional application No. 63/079,759, filed on Sep. 17, 2020.

(51) Int. Cl. G06Q 20/18; G06Q 20/20; G07F 15/00; G06Q 50/06; G06Q 10/02

(52) U.S. Cl. CPC G06Q 20/18; G06Q 20/20; G06Q 10/02; G06Q 50/06; G07F 15/00

(57) ABSTRACT

A campsite utility access pedestal is disclosed. The campsite utility access pedestal comprises an input port configured to receive a utility. The campsite utility access pedestal also comprises an output port configured to supply a campsite with the utility. A coupling mechanism is configured to couple the input port to the output port when the coupling mechanism is actuated. A control board is configured to actuate the coupling mechanism in response to receiving an indication of payment for the utility.

### CROSS-REFERENCE TO RELATED APPLICATIONS

This patent application claims the benefit of U.S. Provisional Patent Application No. 63/079,759 filed Sep. 17, 2020 by Damon Tucker and Larry Crimm, and titled “Point-Of-Sale Utility Unit For Recreational Vehicles,” which is hereby incorporated by reference.

### BACKGROUND

Recreational Vehicle (RV) usage has recently surged nationwide due to coronavirus disease 2019 (COVID-19)-related travel restrictions. Year over year camper sales have doubled as well, which indicates a long-term upward trend in this type of travel mode. The sudden increase in RV popularity brings challenges to a typically slower-paced industry. Traditional RV parks employ attendants for check in/check out, which inherently adds to the risk transmission of the COVID-19 infection. However, not having an attendant on duty puts park owners at risk for nonpayment as campers may move on when the park attendant is gone or otherwise engaged. There is also the ever-present threat of robbery (internal or external) in an office that keeps cash on hand.

### SUMMARY

In an example, the disclosure includes a campsite utility access pedestal comprising: an input port configured to receive a utility; an output port configured to supply a campsite with the utility; a coupling mechanism configured to couple the input port to the output port when the coupling mechanism is actuated; and a control board configured to actuate the coupling mechanism in response to receiving an indication of payment for the utility.

In another example, the disclosure includes a method implemented in a campsite utility access pedestal, the method comprising: receiving a utility at an input port; receiving an indication of payment; actuating a coupling mechanism to couple the utility from the input port to an output port in response to receiving the indication of payment; and supplying, by the output port, a utility to a campsite in response to actuation of the coupling mechanism.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an example campsite utility access pedestal.

FIG. 2 is a diagram of another example campsite utility access pedestal.

FIG. 3 is a flowchart of an example method of operating a campsite utility access pedestal.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a campsite utility access pedestal, which may also be known as a park-and-pay RV pedestal, that solves the abovementioned problems by creating a cashless self-service environment that provides campers with additional control over vacation schedules and provides park owners with increased safety and security during park operations. The park-and-pay RV pedestal provides a point-of-sale interface to allow campers to purchase utilities and/or pad space for a specified length of time. For example, users may use credit cards or other remote pay technology, such as near field communication (NFC) or radio frequency identification (RFID), to purchase electricity, water, sewage, RV parking, Internet access, and/or other services without directly interacting with park staff. The pedestal may decrease the expenses of around-the-clock attendants by allowing customers to self-serve at the pedestal. The pedestal may also reduce the risk of robbery by instituting cashless transactions. Further, the pedestal may decrease theft of services by nonpayment. For example, the utility access pedestal includes an input port that receives a utility and an output port that provides one or more utilities. The utility access pedestal also includes a coupling mechanism coupled between input port and output port. The utility access pedestal also includes a control board that controls the coupling mechanism. The utility access pedestal may also comprise a payment unit and/or a communications port that can be used to process payment from a user. The control board can actuate the coupling mechanism in response to receiving an indication of payment to provide the utility to output port, and hence provide utilities to the user at the campsite. The control board may include a timer, and may be configured to actuate the coupling mechanism and remove the utilities after a duration. The utility access pedestal may also include status indicators, which are controlled by the control board and indicate whether the campsite is available, reserved, or in use. The utility access pedestal may also be configured to communicate with a network to indicate status changes at the campsite and/or receive indications of payments for Internet based payment processing.

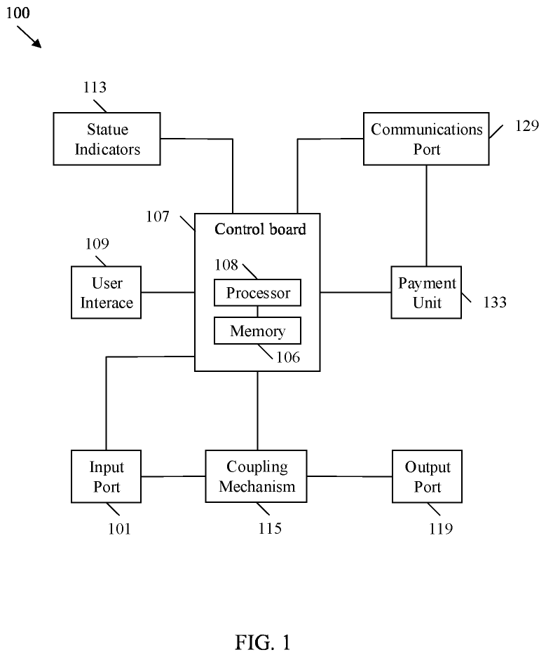

FIG. 1 is a diagram of an example campsite utility access pedestal 100. The campsite utility access pedestal 100 is a generalized model that can be employed to implement a pedestal for providing automated access to utilities at a campsite. For example, the campsite utility access pedestal 100 can be positioned adjacent to an RV pad and can be used to provide utility hookups for an RV. As another example, the campsite utility access pedestal 100 can be positioned to provide utilities for tent camping at an improved campsite.

The campsite utility access pedestal 100 may be implemented as a water-resistant container, such as an outdoor junction box, that includes various electrically actuated components. The campsite utility access pedestal 100 may comprise varying components depending on the desired functionality of the campsite utility access pedestal 100. For example, the campsite utility access pedestal 100 may comprise at least an input port 101, an output port 119, a coupling mechanism 115 coupling the input port 101 to the output port 119, and a control board 107 coupled to the coupling mechanism 115.

The input port 101 can be any device capable of receiving a utility and providing the utility to the campsite utility access pedestal 100. For example, the input port 101 may include receivers for receiving a ground line and electrical line(s), which may conduct alternating current (AC) power. For example, the electrical lines may include a pair of 120v lines. The input port 101 is configured to provide the utility to the other components in the campsite utility access pedestal 100. For example, the input port 101 is configured to provide power to the output port 119. In another example, the input port 101 may include a pipe for receiving water (e.g., pressurized water, a sewage drain, etc). In examples, the input port 101 may include communications equipment for providing other utilities, such as television, Internet access, etc.

The output port 119 is configured to supply one or more utilities at a campsite when connected to the input port 101. The output port 119 can include different components depending on the desired utility. For example, the output port 119 can include one or more electrical plugs in the event that the utility is electrical power. In another example, the output port 119 can include a hose that can provide water to a campsite. In other examples, the output port 119 can include components for receiving waste from an RV tank, components for connecting cable television lines, components for providing Internet access, etc. Regardless of the example, the output port 119 is configured to selectively provide access to one or more utilities when connected to power.

The coupling mechanism 115 is configured to couple the power from the input port 101 to the output port 119 when actuated. For example, the coupling mechanism 115 may be implemented as a contactor coil that can be actuated to complete an electrical circuit between the input port 101 and the output port 119. The coupling mechanism 115 may be a valve for controlling the flow of water between the input port 101 and the output port 119. The coupling mechanism 115 may also be any other electronic, electrical, or electro-magnetically controlled switching device. In the event that multiple utilities are provided by the output port 119, the coupling mechanism 115 may include multiple switching components to selectively provide access to each and/or all utilities.

The control board 107 is coupled to the coupling mechanism 115. Further, the control board 107 is configured to controllably actuate the coupling mechanism 115, and therefore provide the utility to the campsite upon receiving an indication of payment. For example, the control board 107 may be electrically connected to, and receive a constant supply of power from, the input port 101. The control board 107 may include any computing circuitry desired to selectively control the coupling mechanism 115 under desired conditions. For example, the control board 107 may include a processor 108 and memory 106. The processor 108 may be implemented as one or more central processing unit (CPU) chips, cores (e.g., as a multi-core processor), field-programmable gate arrays (FPGAs), application specific integrated circuits (ASICs), digital signal processors (DSPs), or any other processing circuitry capable of executing instructions to provide desired functionality. The memory 106 may include any storage device capable of storing software instruction and/or storage variables. For example, the memory 106 may include random access memory (RAM), cache memory, flash memory, read only memory (ROM) or other memory circuitry suitable to this task. As an example, the control board 107 may receive an indication that a user has paid for the utility or utilities and may actuate the coupling mechanism 115 (or coupling mechanisms 115) to connect the utility to the output port 119 in order to provide utility access. Further, the control board 107 may include a timer and may be configured to automatically actuate the coupling mechanism 115 to decouple the utility from the output port 119 to disconnect the utility from the campsite after a predetermined and/or specified duration.

The campsite utility access pedestal 100 may also comprise various components to provide input to, or feedback, from the control board 107, depending on the desired functionality. In an example implementation, the campsite utility access pedestal 100 may be configured to receive credit card or other payment methods. In such an example, the campsite utility access pedestal 100 comprises a payment unit 133. The payment unit 133 is coupled to the control board 107. Further, the payment unit 133 is configured to process payment from a user and/or provide the indication of payment to the control board 107 when the payment is successfully processed. For example, the payment unit 133 may comprise a credit card reader and/or a contactless payment reading mechanism such as a radio frequency identification (RFID) reader, a near field communications (NFC) communications device, etc. In such a case, the payment unit 133 is configured to receive the payment from the corresponding mechanism, communicate with a network to process the payment, and indicate to the control board 107 that payment is successful. In another example, the payment unit 133 may receive coins and/or dollar bills and indicate to the control board 107 when sufficient payment is received.

The campsite utility access pedestal 100 may also comprise a communications port 129. The communications port 129 may be coupled to the control board 107, the payment unit 133, or both. The communications port 129 may contain various communications equipment to support the various embodiments discussed herein. For example, the communications port 129 may include a cellular interface, for example a third generation partnership project (3GPP) transmitter and receiver (transceiver), such as a long term evolution (LTE) transceiver, a fourth generation cellular network (4G) transceiver, a fifth generation cellular network (5G) transceiver, etc. In other examples, the communications port 129 may include a phone modulator-demodulator (modem), a digital subscriber line (DSL) modem, a cable modem, an fiber optic modem, a satellite transceiver, an institute of electrical and electronics engineers (IEEE) 802.11 (Wifi) device, etc. In some examples, the payment unit 133 processes payment via communications with the communications port 129. In other examples, the campsite utility access pedestal 100 is configured to allow users to reserve campsites and/or pay for utilities via a web portal. In such a case, the indication of payment may be received by the control board 107 and/or the payment unit 133 via the communications port 129. Further, the control board 107 may be configured to report a campsite status to a network via the communications port 129. For example, the control board 107 may transmit a packet via the communications port 129 to indicate when a campsite's status changes between available, reserved, and in use. For example, available may indicate that the campsite is open for anyone to use. Reserved may indicate that a user has temporarily reserved the campsite for their use, but has not yet paid for the campsite and/or utilities. In use may indicate that a user has paid for the campsite and/or utilities for a specified and/or predefined duration. In such a case, the packet may be forwarded to a web portal to allow the campsite status to be viewed by park attendants and/or other users, depending on the desired functionality. It should be noted that, in some examples, the communications port 129 may contain utilities that could be purchased by the user. In such cases, the communications port 129 may be part of the input port 101, interfaces to the communications port 129 may be located in the output port 119, and the communications port 129 may be coupled to the output port 119 via the coupling mechanism 115.

The campsite utility access pedestal 100 may also comprise a user interface 109. The user interface 109 may include an input device to receive inputs from the user, such as a touch pad, a touch screen, a keyboard, a key pad, a trackball, etc. The user interface 109 may also include an output device to provide feedback to the user. For example, the user interface 109 may include a screen, such as a liquid crystal display (LCD) screen, a speaker, and/or any other device for user feedback. The user interface 109 is coupled to the control board 107. For example, the user interface 109 can be configured to receive input to support processing the payment from the user. As a specific example, the user interface 109 may allow the user to select a duration to reserve the campsite and/or utilities, to pay for the reservation and/or utilities, extend an ongoing reservation, etc.

The campsite utility access pedestal 100 may also comprise status indicators 113. The status indicators 113 are coupled to the control board 107, and may be configured to provide feedback regarding campsite status. For example, the status indicators 113 may include colored lights configured to indicate the campsite status as reserved, available, or in use. As a specific example, a yellow light may indicate the campsite is reserved, a green light may indicate the campsite is available, and a red light may indicate the campsite is in use. As an example, the status indicator may allow park attendants to determine which campsites have been paid for upon casual inspection. The status indicators 113 may be controlled by the control board 107. Accordingly, the control board 107 can indicate when a status changes by controlling the status indicators 113. It should be noted that the status indicators 113 can be used instead or in addition to reporting via the communications port 129.

As shown above, the campsite utility access pedestal 100 can be implemented using various technologies, components, and configurations to provide varying functionality as desired. This flexibility allows for different designs based on the desired functions and/or the constraints present at the campsite. The following disclosure includes example software and/or hardware implementations that can be used to implement specific embodiments of the campsite utility access pedestal 100.

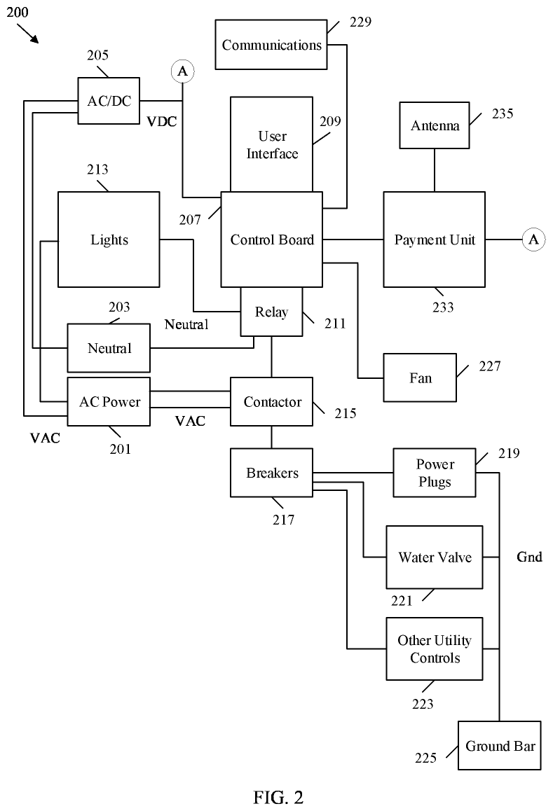

FIG. 2 is a diagram of another example campsite utility access pedestal 200. As noted above, the campsite utility access pedestal 200 is an example implementation of the campsite utility access pedestal 100. The campsite utility access pedestal 200 includes an AC power port 201, a ground bar 225, and a neutral port 203, which may implement the functionality of the input port 101. In an example, the AC power port 201 receives two 120 v electrical lines as input and couples the electrical lines to the other components in the pedestal. The ground bar 225 is connected to a ground wire input and provides a direct connection to ground for the campsite utility access pedestal 200. The neutral port 203 receives a neutral connection, which may be connected (bonded) to ground. The neutral port 203 provides a neutral connection to the campsite utility access pedestal 200 for switching/coupling in order to complete relevant circuits.

The campsite utility access pedestal 200 also comprises power plugs 219, which may implement the functionality of the output port 119. Accordingly, when the output port includes a power plug 219, the utility provided by the pedestal includes AC electrical power. In an example, the power plug 219 may include multiple plugs for different purposes. For example, the power plug 219 may include a 120 v ground fault interrupt (GFI) plug that can provide power to household consumer products. The power plug 219 may also include a thirty amperage (amp) plug and/or a fifty amp plug configured to provide power to various RV power inputs. The campsite utility access pedestal 200 may also comprise a water valve 221, which can also implement a coupling mechanism 115. Accordingly, when the coupling mechanism 115 includes a water value, the utility provided by the pedestal includes is water. Further, the campsite utility access pedestal 200 may also comprise other utility controls 223 to implement the coupling mechanism 115, which may control other utilities as desired. Accordingly, the campsite utility access pedestal 200 can provide various utilities depending on the example.

The campsite utility access pedestal 200 also comprises a contactor 215, which may implement the functionality of the coupling mechanism 115. A contactor 215 is an electrically controlled switch used for switching an electrical power circuit. Specifically, the contactor 215 is coupled in an electrical circuit between the AC power port 201 and the power plugs 219, the water valve 221, and/or the other utility controls 223. The power plugs 219, the water valve 221, and/or the other utility controls 223 are coupled to the ground bar 225. Accordingly, the contactor 215 can be switched to provide power from the AC power port 201 toward the ground bar 225 via the power plugs 219, the water valve 221, and/or the other utility controls 223. As such, when switched, the contactor 215 can complete the circuit and actuate the power plugs 219, the water valve 221, and/or the other utility controls 223 to provide the relevant utility or utilities. In an example, the contactor 215 includes power contacts that connect to the AC power port 201 and the relevant output port. The contactor 215 may also include an electromagnet that closes the switch and connects the power contacts when energized and a spring that opens the switch when the electromagnet is not energized. The electromagnet in the contactor 215 is also connected to the AC power port 201 via a separate connection than the connection coupling to the power contacts.

The campsite utility access pedestal 200 also comprises a control board 207, which may be substantially similar to control board 107. The control board 207 is powered by direct current (DC) power. Accordingly, the campsite utility access pedestal 200 includes an AC to DC converter (AC/DC) 205. The AC/DC 205 is coupled to the AC power port 201 and neutral port 203 and outputs DC voltage (VDC). The control board 107 is coupled to, and powered via, the VDC output from the AC/DC 205. Since the control board 207 is powered from the AC power port 201 without a switch, the control board 207 may remain constantly active. The campsite utility access pedestal 200 also comprises a relay 211, which is another switch. The relay 211 is coupled to the control board 207. A relay 211 may be implemented by various technologies, but a relay 211 is generally used for low power signals. In the campsite utility access pedestal 200, the relay 211 is connected to the neutral port 203 and the contactor 215. When the control board 207 sends a signal to the relay 211, the relay connects the electromagnet in the contactor 215 to the neutral port 203. Since the electromagnet in the contactor 215 is connected to AC power port 201, connecting the neutral port 203 to the electromagnet completes a circuit and energizes the electromagnet, which actuates the contactor 215. Accordingly, the control board 207 is configured to employ the relay 211 to actuate the contactor 215 by coupling the contactor 215 to a neutral line from the input port.

The campsite utility access pedestal 200 may also include breakers 217 coupled between the contactor 215 and the power plugs 219, the water valve 221, and/or the other utility controls 223. The breakers 217 may be employed for safety purposes. For example, a user at the campsite can flip the breakers to manually shut off utilities. Further, the breakers 217 can be configured to automatically flip and disconnect utilities in the case of power surges.

The campsite utility access pedestal 200 also includes a payment unit 233, which may be substantially similar to payment unit 133. In an example, the payment unit 233 may include a credit card reader. The payment unit 233 may be connected to, and powered via, the AC/DC 205. The payment unit 233 is also connected to the control board 207. The campsite utility access pedestal 200 also comprises an antenna 235, which may implement a communications port 129. The antenna 235 may be a cellular antenna and may be powered via the payment unit 233. The payment unit 233 is connected to the antenna 235. Accordingly, the payment unit 233 is configured to receive payment, process payment via the antenna 235, and provide the indication of payment to the control board 207. Accordingly, the control board 207 can control the relay 211 and actuate the contactor 215 to provide utilities when payment is processed by the payment unit 233.

The campsite utility access pedestal 200 may comprise a user interface 209, which may be substantially similar to the user interface 109. The user interface 209 is connected to the control board 207 and can be used to provide visual feedback to users in order to support making payments via the payment unit 233.

The campsite utility access pedestal 200 may also include a plurality of lights 213, for example light emitting diodes (LEDs). The lights 213 may implement the functionality of the status indicators 113. The lights 213 may be connected to AC power port 201 and the relay 211. Accordingly, the control board 207 can actuate the relay 211 to selectively provide a neutral port 203 connection to complete the electrical circuit to a corresponding light in the lights 213. As such, the control board 207 can control the lights 213 to indicate changes in status at the campsite based on payments from the payment unit 233, expiration of payments after a duration, etc.

The campsite utility access pedestal 200 may also include other communications 229, which may also implement communications port 129. The communications 229 may include a modem and a physical connection to the internet and/or an antenna. In some examples, the communications 229 may be combined with antenna 235. The control board 207 is connected to the communications 229 when present. In these examples, the control board 207 can communicate status changes of the campsite to a web portal via the communications 229. Further, in some examples the control board 207 can receive indications of payments via the communications 229 in order to allow users to purchase utilities via the web portal. In yet further examples, the web portal may indicate to the control board 207 via the communications 229 when a user reserves a campsite via the Internet. In cases, the control board 207 may actuate the contactor 215 and/or change the status displayed by the lights 213 based on data received from the communications 229.

The campsite utility access pedestal 200 may also comprise a fan 227, such as a universal serial bus (USB) fan connected to the control board 207. The fan 227 can be activated to selectively cool the components of the pedestal 200 to prevent overheating.

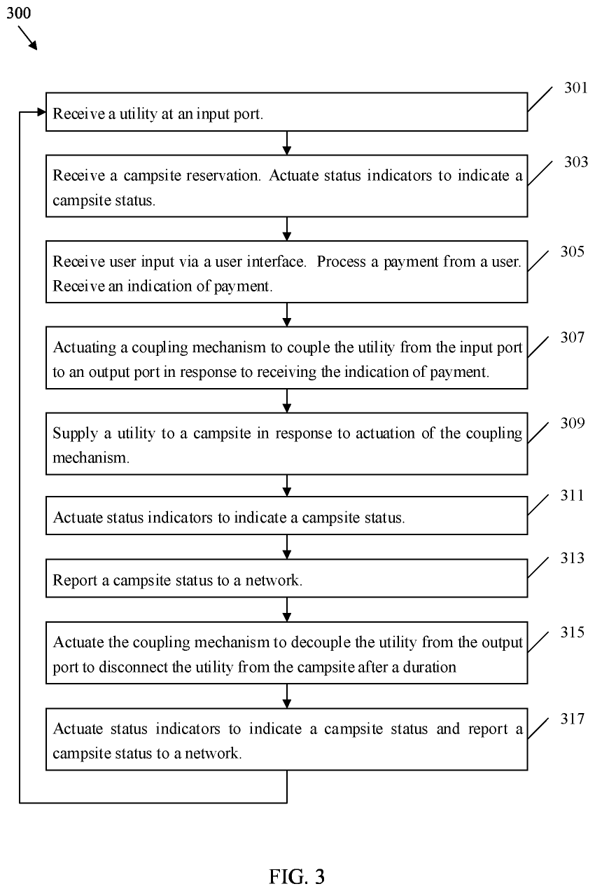

FIG. 3 is a flowchart of an example method 300 of operating a campsite utility access pedestal, such as a pedestal 100 and/or 200. Method 300 may begin when a campsite utility access pedestal is setup at a campsite. At step 301, the campsite utility access pedestal receives a utility, such as electrical power, water, etc., at an input port. In the electrical power example, the power may be AC electricity, such as residential level 240V A/C power. The campsite utility access pedestal may default to actuating a status indicator (e.g., one of a plurality of lights, such as a green light) to indicate that the campsite is available.

At optional step 303, the campsite utility access pedestal may receive a campsite reservation via a communications port. The control board may actuate the status indicators to indicate a change in campsite status. For example, the control board may employ a relay to switch a green light off and switch a yellow light on to indicate that the campsite is reserved for a particular guest and not available for general use.

At step 305, the campsite utility access pedestal may receive user input via a user interface to support processing the payment from the user. For example, the user may interact with a keypad and swipe a credit card in a payment unit to pay for utilities. In an example, the user may also use the user interface to request/set a duration until the campsite and/or utility purchase is set to expire. The payment unit may then process the payment from the user. For example, the payment unit may communicate via an antenna to request that a third party system perform a transaction. Once the transaction is complete, the payment unit can transmit an indication of payment to the control board. It should be noted that in some examples, steps 303 and 305 may be combined. For example, a user may pay for the utilities as part of the reservation. In such a case, the transaction may be performed via the Internet, and the indication of payment may be sent directly to the control board from the communications port or to the control board via the payment unit, depending on the example. Regardless of the example, the control board receives an indication of payment. Further, the indication of payment is received in response to processing the payment.

At step 307, the control board actuates a coupling mechanism to couple the utility from the input port to an output port in response to receiving the indication of payment. This results in supplying a utility from the output port to a campsite in response to actuation of the coupling mechanism at step 309. In some examples, the output port is a power plug, in which case the utility provided is AC electrical power. In some examples, the output port is a water valve, in which case the utility is water. As noted above, the output port can also include other components to provide other utilities as desired. In some examples, the coupling mechanism is a contactor connected to the input power and connected to AC power, but not connected to ground or neutral. In such a case, actuating the coupling mechanism comprises controlling a relay to couple the contactor to a neutral line from the input port. By coupling the contactor to the neutral line, and electromagnet is energized causing the contactor to actuate and connect the input port to the output port.

At step 311, the control board actuates the status indicators to indicate a change in campsite status. For example, the control board may employ the relay to switch the yellow light off and the red light on to indicate that the campsite is in use and therefore paid for and not available for other users.

At optional step 313, the control board can report a change in campsite status to a network via the communications port. For example, the control board can send a packet to a web portal to indicate the campsite is in use. Further, the control board may indicate to the network the duration until the in use status is set to expire.

The control board may employ a counter to measure time until the reservation of the campsite expires. At the end of the duration, the control board may actuate the coupling mechanism to decouple the utility from the output port in order to disconnect the utility from the campsite at step 315. The control board can then actuate the status indicators to indicate the change in campsite status at step 317. For example, the control board may employ the relay to switch the red light off and the green light on to indicate that the campsite is no longer in use and therefore available for use by other users. In an example, the control board may also report the campsite status change to the network via the communications port.

In summary, the disclosed pedestal that solves the problems described herein by creating a cashless self-service environment that provides campers with additional control over vacation schedules and provides park owners with increased safety and security during park operations. The pedestal provides a point-of-sale interface to allow campers to purchase utilities and/or pad space for a specified length of time. For example, users may use credit cards or other remote pay technology, such as near field communication (NFC) or RFID, to purchase electricity, water, sewage, RV parking, Internet access, and/or other services without directly interacting with park staff. The pedestal may decrease the expenses of around-the-clock attendants by allowing customers to self-serve at the pedestal. The pedestal may also reduce the risk of robbery by instituting cashless transactions. Further, the pedestal may decrease theft of services by nonpayment

An example embodiment of the pedestal may function as follows. Input power of 240 VAC may be received from the park service at the distribution block in the pedestal. The power may be split into one 240 volt AC output and two 120 volt AC outputs. The 240 AC line travels to a 240 V contactor that is energized by a 120 V AC coil. From there, the 240 V line may travel to a din rail that houses a fifty amp breaker and two thirty amp breakers. The fifty amp breaker can connect to a fifty amp RV receptacle plug. One of the thirty amp breakers can connect to a thirty amp RV receptacle plug and the other thirty amp breaker connects to 120 V receptacle.

Back at the distribution block, one of the 120 V lines may connect to a track mount pilot relay (HOA) with a 10-30 DC/120 VAC coil. From there, the 120V line may connect to the 120 V AC coil on the contactor. The second 120 V line from the distribution block may connect to a 120 v AC/12-48V DC transformer. The DC line may plug into a control board, such as a single board computer (SBC), as well as a card reader/telemeter or other point-of-sale collection device (such as a contactless wireless payment device). The SBC may communicate to the card reader by serial port via a software system. The SBC may also communicate with a user interface, such as a LCD screen and keypad, which offers selections to the user. Selections may include preset time intervals, services, and the price for each interval and/or service. Once the user makes a selection, the software may communicate with the card reader and the reader may charge the corresponding amount to the user's card/account. A third-party vendor may monitor each card reader, authenticate every purchase, and produce customer reports for the pedestal owner.

Once the monetary transaction is authenticated and concluded, the card reader may communicate to the SBC to start the time interval countdown and the 10V DC output that energizes the HOA, which allows the 240 v AC contactor to pass current to the plugs. At this point, the user can plug in an RV and receive full electrical service for the duration of the paid for interval.

When the timer reaches the end of the paid for interval, the SBC cuts the ten volts DC output, effectively shutting off current to the RV. There may be a timer display on the LCD pad that allows the customer to see how much time is left in the reservation. If the user would like to add more time, this can be done at any point. In an example embodiment, the controller/SBC can act as an access point for other services, such as water, sewage, and/or Internet access. Such services may be connected via the pedestal or via other components.

The software allows the RV park administrator to customize time intervals and prices based on location, usage history, and various other market drivers. The pedestal may be designed for new construction, which will allow the pedestal to be buried. The pedestal may also be designed for use with existing campsites and may not require digging for placement. The pedestal may be attached to a trailer screw-type tie down by an allthread through the pedestal with a tightening nut on the top.

In another example, a plurality of campsite utility access pedestals can be controlled by a single control pedestal by using a hub and spoke model. In this example, each campsite utility access pedestal may operate substantially as described above. However, control functionality can be managed by a single control pedestal. The control pedestal may comprise a master control board configured to actuate coupling mechanisms at the campsite utility access pedestals in response to receiving an indication of payment for utilities. For example, the master control board can connect to a local control board at each campsite utility access pedestal via wireless or wired communication. A user can interact with the master control board at the control pedestal to manage payment functions. The master control board can then direct the local control board at the specified campsite utility access pedestal to actuate the corresponding coupling mechanism and connect the relevant utility. In such a case, one payment system can control multiple campsite locations. The control pedestal can include any of the supporting components described herein to communicate and manage payment.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A campsite utility access pedestal comprising:
an input port configured to receive a utility;
an output port configured to supply a campsite with the utility;
a coupling mechanism configured to couple the input port to the output port when the coupling mechanism is actuated; and
a control board configured to actuate the coupling mechanism in response to receiving an indication of payment for the utility.

2. The campsite utility access pedestal of claim 1, further comprising a payment unit coupled to the control board, wherein the payment unit is configured to:
process a payment from a user; and
provide the indication of payment to the control board when the payment is successfully processed.

3. The campsite utility access pedestal of claim 2, further comprising a user interface coupled to the control board, wherein the user interface is configured to receive input to support processing the payment from the user.

4. The campsite utility access pedestal of claim 1, wherein the output port is a power plug, and wherein the utility is alternative current (AC) electrical power.

5. The campsite utility access pedestal of claim 1, wherein the coupling mechanism is a valve, wherein the output port is a hose, and wherein the utility is water.

6. The campsite utility access pedestal of claim 1, further comprising a relay coupled to the control board, wherein the coupling mechanism is a contactor, wherein the control board employs the relay to actuate the contactor, and wherein the relay actuates the contactor by coupling the contactor to a neutral line from the input port.

7. The campsite utility access pedestal of claim 1, further comprising status indicators configured to indicate a campsite status of reserved, available, or in use, wherein the control board is further configured to control the status indicators.

8. The campsite utility access pedestal of claim 7, wherein the status indicators include a plurality of lights.

9. The campsite utility access pedestal of claim 1, further comprising a communications port coupled to the control board, wherein the control board is further configured to report a campsite status to a network via the communications port.

10. The campsite utility access pedestal of claim 1, wherein the control board is further configured to actuate the coupling mechanism to decouple the utility from the output port to disconnect the utility from the campsite after a duration.

11. A method implemented in a campsite utility access pedestal, the method comprising:
receiving a utility at an input port;
receiving an indication of payment;
actuating a coupling mechanism to couple the utility from the input port to an output port in response to receiving the indication of payment; and
supplying, by the output port, a utility to a campsite in response to actuation of the coupling mechanism.

12. The method of claim 11, further comprising processing a payment from a user, wherein the indication of payment is received in response to processing the payment.

13. The method of claim 12, further comprising receiving user input via a user interface to support processing the payment from the user.

14. The method of claim 11, wherein the output port is a power plug, and wherein the utility is alternative current (AC) electrical power.

15. The method of claim 11, wherein the coupling mechanism is a valve, wherein the output port is a hose, and wherein the utility is water.

16. The method of claim 11, wherein the coupling mechanism is a contactor, and wherein actuating the coupling mechanism comprises controlling a relay to couple the contactor to a neutral line from the input port.

17. The method of claim 11, further comprising actuating status indicators to indicate a campsite status of reserved, available, or in use.

18. The method of claim 17, wherein the status indicators include a plurality of lights.

19. The method of claim 11, further comprising reporting a campsite status to a network via a communications port.

20. The method of claim 11, further comprising actuating the coupling mechanism to decouple the utility from the output port to disconnect the utility from the campsite after a duration.

21. A campsite utility access system comprising:
a plurality of campsite utility access pedestals, each campsite utility access pedestal comprising:
an input port configured to receive a utility;
an output port configured to supply a campsite with the utility; and
a coupling mechanism configured to couple the input port to the output port when the coupling mechanism is actuated; and
a single control pedestal comprising a master control board configured to actuate coupling mechanisms at the campsite utility access pedestals in response to receiving an indication of payment for utilities.

22. The campsite utility access system comprising of claim 21, wherein each campsite utility access pedestal comprises a local control board configured to actuate the coupling mechanism at the corresponding campsite utility access pedestal, and wherein the master control board is further configured to control each local control board.

23. The campsite utility access system comprising of claim 22, wherein the master control board controls the local control boards via wireless communication.

24. The campsite utility access system comprising of claim 22, wherein the master control board controls the local control boards via wired communication.
